(19) United States
(12) Patent Application Publication
(10) Pub. No.: US 2015/0093199 A1
(43) Pub. Date: Apr. 2, 2015

(54) Contaminated Soil Purification Method

(71) Applicants: Chemical Grouting Co., Ltd., Tokyo (JP); EOS Remediation, LLC, Raleigh, NC (US)

(72) Inventors: Robert C. Borden, Raleigh, NC (US); Junichi Yamanobe, Tokyo (JP); Susumu Uesawa, Tokyo (JP); Miho Yoshikawa, Tokyo (JP)

(73) Assignees: Chemical Grouting Co., Ltd., Tokyo (JP); EOS Remediation, LLC, Raleigh, NC (US)

(21) Appl. No.: 14/219,425

(22) Filed: Mar. 19, 2014

(30) Foreign Application Priority Data
Oct. 2, 2013 (JP) 2013-206956

(51) Int. Cl. B09C 1/10

(52) U.S. Cl. CPC B09C 1/10
USPC 405/128.7

(57) ABSTRACT

A contaminated soil remediation method activates a microorganism in soil contaminated with a toxic chemical substance. The contaminant is decomposed by a biodegradation reaction of the microorganism. The method involves forming a boring hole reaching into contaminated soil. A rod whose end is provided with a jet device is inserted into the boring hole. The contaminated soil is cut in a manner forming a flat-plate area in which the soil is intermittently cut by a microorganism activator, and the soil and the microorganism activator are mixed, by jetting water and/or the microorganism activator from the jet device.

### CROSS-REFERENCE TO RELATED APPLICATIONS

This application is related to and claims priority to the filing date of Japan Patent Application No. 2013-206956, filed Oct. 2, 2013, the disclosure of which is specifically incorporated in its entirety by reference herein.

### FIELD OF THE INVENTION

This invention relates to methods and devices for remediating soil contaminated with toxic chemical substances such as volatile organic compounds (VOC), by using microorganisms to effect the remediation.

### BACKGROUND

In general, an organic chlorine compound such as tetrachloroethylene and trichloroethylene is considered to be a toxic chemical substance due to the significant adverse environmental impacts attributable to its hazardous properties and persistency. In recent years, there have been growing concerns about soil and groundwater pollution resulting from chemical substances such as tetrachloroethylene and trichloroethylene.

In addition, more prompt actions are needed to remediate soil and groundwater contaminated with a toxic chemical substance.

One of the technologies for remediating soil contaminated with a toxic chemical substance such as tetrachloroethylene and trichloroethylene by using a microorganism is “bioremediation.” This microorganism-based remediating technology is advantageous in lower costs when compared to a soil remediation technology by physical and chemical treatments, and it is also easier to remediate the contaminated soil in situ.

Bioremediation known as “bioaugmentation” remediates a contaminated soil by adding a microorganism (from outside the contaminated soil), which is highly capable of decomposing the contaminant. Bioremediation known as “biostimulation” remediates a contaminated soil through a biodegradation reaction of a microorganism by activating microorganisms present in an in-situ soil by supplying a nutrient source to the in-situ soil.

The “biostimulation” type of bioremediation employs an (indigenous) microorganism present in a contaminated soil (in-situ soil) to be purified, which will be purified by adding nutrients and other ingredients thereto, resulting in advantages such as reduction in work and costs. Accordingly, “biostimulation” has been regarded as an effective technology for remediating a contaminated soil in situ.

Organic chlorine compounds having a large number of chlorines such as tetrachloroethylene (PCE) and trichloroethylene (TCE) are accordingly decomposed by biodegradation reaction (reductive declorination reaction) by using an anaerobic microorganism. More specifically, various types of soil remediation technologies by using an anaerobic microorganism have conventionally been proposed, for example, by Japanese Patent No. 4079976. In such a conventional technology, a remediating agent is injected into the soil as an emulsion. The injected emulsion diffuses into the soil and ground water due to fluidity of the emulsion itself.

However, in the conventional technology described in that patent, since no diffusion of the emulsion occurs in a low permeable soil contaminated with a chemical substance, it is difficult to remediate the entire contaminated soil to be purified.

In order to remediate the entire soil contaminated with a chemical substance by the above conventional technology described in the Japan patent, it is preferable to permeate the emulsion over the entire area, but the conventional technology described in that patent unfortunately fails to disclose the related technology needed to make it effective. Thus, the conventional technology of the Japan patent is prone to a problem of no emulsion diffusion into the contaminated soil to be purified and resulting generation of a microorganism-inactive area.

### SUMMARY

### Problems to be Solved by the Invention

The present invention was made to solve the problems mentioned above, and was intended to provide a contaminated soil remediation method capable of activating a microorganism over the entire soil contaminated with a toxic chemical substance and decomposing a contaminant by biodegradation reaction of the microorganism.

### Means for Solving the Problems

The contaminated soil remediation method of the present invention comprises:

a process of forming a boring hole (including not only cutting by jetting high-pressure water for drilling but also forming a hole by driving or pushing-in) for forming a boring hole (3) reaching a contaminated soil (Gp) (extending in the vertical direction or a direction tilted relative to the vertical direction);

a jet device inserting process for inserting a rod (1) whose end is provided with a jet device (2) into the boring hole (3); and

a soil cutting process for forming a flat-plate area (6) in which the soil (Gp) is intermittently cut (by a high-pressure water, a microorganism activator (7), etc.) (in the longitudinal and/or the horizontal direction of the boring hole (3)) and the soil (Gp) and the microorganism activator (7) are mixed, by jetting the microorganism activator (7) from the jet device (2), wherein

the microorganism activator (7) is preferably characterized by:

a first component which may be selected from the group made up of short chain fatty acids, short chain fatty acid salts, an alcohol and a carbohydrate;

a second component which may be selected from the group made up of a soybean oil, a corn oil, a canola oil, an olive oil, a peanut oil, a coconut oil, a palm oil, a rape oil, a fish oil, a butter, a jojoba oil, a carnauba wax and a long chain fatty acid; and

a third component which may be a surfactant.

By the term “jetting” is meant to dispense a jet of droplets under pressure out of an opening or nozzle. By the term “jet” is meant a fluid stream forced under pressure out of an opening or nozzle.

In the present invention, it is preferable that a median particle diameter of particles making up the microorganism activator (7) is 0.3 to 3.0 μm, and are stable at a pressure of 50 MPa or less (e.g. 400 bar). It also is preferable that during the soil cutting process for forming the flat-plate area (6) in which the soil (Gp) is intermittently cut (by a high-pressure water, a microorganism activator (7), etc.) and the soil (Gp) and the microorganism activator (7) are mixed, by jetting the microorganism activator (7) from the jet device (2), the pressure of the water being approximately <100-1,000 psi.

While specific components have been listed, it will be appreciated that one component may be any component effective to activate anaerobic microorganisms. Another component may be any component that activates aerobic microorganisms.

In an alternate alternative embodiment, a single component makes up the microorganism activator (7) which comprises at least one of a soybean oil, a corn oil, a canola oil, an olive oil, a peanut oil, a coconut oil, a palm oil, a rape oil, a fish oil, a butter, a jojoba oil, a carnauba wax and a long chain fatty acid.

Herein, the statement that the microorganism activator (7) is “stable at a pressure of 50 MPa or under” means that when the microorganism activator (7) having a median particle diameter, prior to injection, within the range of 0.3 to 3.0 μm is injected into the soil with a jet pressure of 50 MPa or less, the median particle diameter of the microorganism activator (7) remains within the range of 0.3 to 3.0 μm. The “median” means a type of statistical representative value and can be found by arranging a finite number of data from lowest value to highest value and picking the middle one.

In the present invention, it is preferable that said microorganism activator (7) further contain at least one of nitrogen, phosphorus and vitamin B12 (cobalamin).

Also, it is preferable that said microorganism activator (7) further contain a sucrose fatty acid ester.

Moreover, preferably, a first component is glycerin, a second component is soybean oil, and water is contained in the microorganism activator (7) in addition to these and any other components.

In the present invention, it is preferable that said microorganism activator (7) be prepared in a concentrated form comprised of about 1% to about 12% by weight of the first component, about 30% to about 65% by weight of the second component and about 1% to about 15% by weight of the third component. It is further preferable that said concentrated form of the microorganism activator (7) comprise water, in an amount by weight of about 8% to about 68%. According to the inventors' current experience, the first component is more preferably between about 4% and 10% and most preferably about 8%, the second component is more preferably between about 40% and 60%, and most preferably about 55%, the third component is more preferably between about 4% and 12%, and most preferably about 10%. Further, the water more preferably comprises most of the balance by weight of the formulation, and in a concentrated formulation most preferably comprises about 24%.

The microorganism activator (7) preferably is made in a concentrated form to reduce storage and shipping space and expense. The microorganism activator (7) can be diluted, and typically will be diluted at the site where it is to be applied. Preferably the dilution will be about 4.6 to 5 parts of water to 1 part of concentrated microorganism activator (7), but dilutions of 20:1 remain within the preferred range, and dilutions as high as 40:1 or even higher are feasible. Those of ordinary skill in the art will readily appreciate that as the microorganism activator (7) is made more dilute, it may be necessary to inject larger volumes in order to achieve effective biostimulation.

In the concentrated form of the microorganism activator (7) as described above, it is the inventors' current belief that if amounts of the first component are less than about 1%, the microorganism activator (7) does not contain sufficient readily biodegradable material to stimulate rapid microbial growth. If amounts of the first component are greater than about 12%, the microorganism activator (7) is rapidly consumed and does not provide an optimally long-term treatment. If amounts of the second component are less than about 30%, the microorganism activator (7) is rapidly consumed and does not provide an optimally long-term treatment. If amounts of the second component are greater than about 65%, the microorganism activator (7) in its concentrated form becomes too viscous for easy use in the field. If amounts of the third component are less than about 1%, the median droplet size of the microorganism activator (7) is too large for good performance. If amounts of the third component are greater than about 15%, the cost of the microorganism activator (7) is increased unnecessarily.

In the present invention, said soil cutting process preferably comprises:

a process for forming said flat-plate area (6) by jetting the microorganism activator (7); and

a process for moving a jet device (2) a predetermined distance (δ) in the longitudinal direction of the boring hole (3) or rotating the jet device (2) at a predetermined angle around the axis of the boring hole (3).

Herein, said flat-plate area (6) may be disk-like, or may have a planar shape other than a circular shape (e.g. a fan shape) and a flat shape.

In addition, said boring hole (3) is cut in the vertical direction, a plurality of said flat-plate areas (6) are formed in a disk-like shape, and the interval in the vertical direction of the flat-plate area (6) (δ) (distance given when the jet device is moved in the vertical direction: pull-up distance of the jet device) is preferably 0.2 to 0.4 m, particularly 0.3 m (FIG. 1).

In the present invention, said flat-plate area (6) is preferably in the form of a flat-plate (one or a plurality of flat-plates) that extends in the vertical direction along the central axis of the longitudinal direction of the boring hole (3) (e.g. vertical axis) (FIG. 9). Herein, if a plurality of flat-plate areas (6A) are present, a plurality of the flat-plate areas (6A) each preferably cross to an adjacent flat-plate area (6A) thereof at the same angle (central angle: α) (FIG. 10).

Alternatively, it is preferable that said boring hole (3B) be tilted to the vertical axis, said flat-plate area (6B) extend in a direction perpendicular to the longitudinal direction of the boring hole (3B) and be formed at a predetermined interval in the longitudinal direction of the boring hole (3B) (FIG. 11).

Moreover, it is preferable that an area (9) that extends in the form of a conical side surface be formed, as a replacement of said flat-plate area (6, 6A) (FIGS. 12 to 15).

In the present invention, said microorganism activator (7) preferably contains any of a component that increases the specific gravity of the microorganism activator (7), a component that increases the viscosity of the microorganism activator (7) and a component that imparts a property of changing the viscosity of the microorganism activator (7) (increasing the viscosity) (so as to be thixotropic or gelatinous).

Furthermore, the present invention preferably comprises a process for additionally injecting said microorganism activator into the flat-plate area in which the contaminated soil is cut by said soil cutting process.

Thus, it is preferable that packers be expanded at a position in said boring hole upward and downward in the vertical direction of the flat-plate area into which said microorganism activator is additionally injected and said microorganism activator be injected between the packers.

Alternatively, it is preferable that a lower end of said boring hole be prepared so that a liquid doesn't leak therefrom and said microorganism activator be injected into the boring hole from the ground.

### Advantageous Effect of the Invention

The present invention having the above-mentioned configuration provides advantageous effects of a bioremediation: low construction costs, easier soil remediating in situ, low environmental load, low carbon emissions and less impact on the operation of facilities in a construction area.

Additionally, the soil cutting process according to the present invention forms a flat-plate area (6) in which a soil (Gp) is intermittently cut in the longitudinal and/or the horizontal direction of the boring hole (3) and the soil (Gp) and the microorganism activator (7) are mixed, thereby providing a microorganism activator (7) to the soil (Gp) contaminated with a toxic chemical substance (e.g. VOC).

The microorganism activator (7) activates a microorganism present underground and the microorganism generates hydrogen by biodegradation reaction of the microorganism activator (7). Generated hydrogen activates and proliferates a microorganism present underground and having a property of biodegrading a toxic chemical substance (e.g. organic chlorine compound and VOC), including such a dechlorinating bacterium as a Dehalococcoides spp. bacterium. Herein, the microorganism, having a property of biodegrading a VOC such as a dechlorinating bacterium, biodegrades a toxic chemical substance (such as a VOC) by reductive declorination reaction.

After a microorganism having a property of biodegrading a toxic chemical substance (such as VOC and organic chlorine compound) such as a dechlorinating bacterium is activated and proliferated, a chemical substance (e.g. organic chlorine compound and VOC) that contaminates the soil is biodegraded by the microorganism to remediate the soil.

Since the present invention intermittently forms the flat-plate area (6) in the longitudinal and/or the horizontal direction of the boring hole (3) in the soil cutting process, it is not necessary to jet said microorganism activator (7) on all the area in the longitudinal and/or the horizontal direction of the boring hole (3) of the contaminated soil (Gp). Instead, said microorganism activator (7) is intermittently jetted only on part thereof.

More specifically, in the present invention, said microorganism activator (7) is jetted not continuously on all the area of the soil (Gp) to be purified in the vertical direction, but said microorganism activator (7) is intermittently jetted on part thereof. In fact, this operation controls reduction in ground proof stress at a construction site. Additionally, construction processes can be reduced, the construction period can be shortened, and construction costs required for remediating a contaminated soil can be saved.

Herein, hydrogen can permeate the soil (Gp), even a low permeable soil (e.g. a soil of an aquitard (G3)). The soil jetted with the microorganism activator (7) is provided with hydrogen generated by a microorganism (hydrogen-generating microorganism) that is present therein. Generated hydrogen permeates a low permeable soil (e.g. a soil of an aquitard (G3)) by molecular diffusion, and is supplied to the area (Gp) to be purified (in the soil) on which the microorganism activator (7) was not directly jetted. Consequently, said microorganism (a microorganism that biodegrades a toxic chemical substance such as a dechlorinating bacterium) present in the area (Gp) is activated and proliferated to biodegrade the toxic chemical substance.

As to a soil having a high permeability, the microorganism activator (7) can permeate the soil, in addition to hydrogen resulting therefrom. If an area (Gp) to be purified is found in the soil having a high permeability, the microorganism activator (7) can permeate even the area (in the soil) on which the microorganism activator (7) was not directly jetted, in addition to hydrogen resulting therefrom, thereby having the microorganism (hydrogen-generating microorganism) in the area (an area on which the microorganism activator (7) was not directly jetted) generate hydrogen. Then, a microorganism such as a dechlorinating bacterium activated by the hydrogen is activated and proliferated to biodegrade a toxic chemical substance.

More specifically, according to the present invention, even if the microorganism activator (7) is not continuously jetted entirely on the contaminated soil (Gp), said microorganism activator (7) (and/or hydrogen) permeates the soil (Gp), thereby having a microorganism such as a dechlorinating bacterium activated by hydrogen activated and proliferated to remediate the entire area of soil contaminated by the chemical substance.

After the microorganism activator (7) is supplied in the soil, the microorganism activator (7) might be subjected to reverse flow to the ground by earth pressure. However, in the present invention, if the specific gravity of the microorganism activator (7) is increased, reverse flow of the microorganism activator (7) from the soil to ground surface (Gf) can be controlled.

Likewise, an increase in the viscosity of the microorganism activator (7) can control the flow of the microorganism activator (7) from the soil (Gp) to the ground, thereby preventing reverse flow to the ground.

Moreover, by imparting a property of changing the viscosity of the microorganism activator (7) (so as to be thixotropic or gelatinous), the flow of the microorganism activator (7) from the soil (Gp) to the ground can be controlled. Thus, reverse flow of the microorganism activator (7) to the ground can be prevented.

Herein, hydrogen generated from the microorganism activator (7) can diffuse in the contaminated soil (Gp) after permeating the thixotropic or gelatinous microorganism activator (7). More specifically, the microorganism activator (7) is made thixotropic or gelatinous so as to have the microorganism activator (7) and/or hydrogen permeate the thixotropic or gelatinous microorganism activator (7) to diffuse in the contaminated soil (Gp).

In the present invention, if the microorganism activator (7) is consumed so as not to contribute to activation of said microorganism, said microorganism is activated again by an additionally injected microorganism activator (7) by additionally injecting said microorganism activator (7) into the flat-plate area (6) cut by said soil cutting process.

Herein, if a particulate (small-diameter) pumice (8) and a fine sand and others are filled in the flat-plate area (6) cut already, a passage for the microorganism activator (7) to permeate (water passage) is formed between the particulate pumice (8) or the fine sand. Under the circumstances, if said microorganism activator (7) is additionally injected into a flat-plate area (6) already jet-drilled in the soil by using e.g. a pair of packers, said microorganism activator (7) reaches the entire flat-plate area (6) via the passage (water passage) to generate hydrogen again and activate said microorganism.

According to the present invention, the microorganism activator (7) jetted underground has a microorganism activator (7) containing first to third components, and the microorganism activator (7) activates an underground-present microorganism that generates hydrogen by biological response, thereby having the microorganism (a hydrogen-generating microorganism) generate hydrogen underground. The generated hydrogen permeates the soil (e.g. a soil of an aquitard (G3)) and reaches the area (Gp) to be purified. Consequently, like a dechlorinating bacterium that decomposes e.g. an organic chlorine compound and a VOC by reductive declorination reaction, a microorganism that decomposes a toxic chemical substance by biodegradation reaction is activated and proliferated. Subsequently, biodegradation reaction decomposes and removes the toxic chemical substance.

The soil having a high permeability can have the microorganism activator (7) permeate the soil, in addition to hydrogen, and reach the area (Gp) to be purified.

As stated above, a toxic chemical substance, such as tetrachloroethylene (PCE) and trichloroethylene (TCE) having a large number of chlorines in particular, is decomposed by reductive declorination reaction of an anaerobic microorganism (e.g. a dechlorinating bacterium).

Said microorganism activator (7) contains a first component (a water-soluble substrate) and a second component (a low solubility substrate). Each of these components serves as a nutrient source for microorganisms, which may be and typically are naturally present. The first component (a water-soluble substrate) is readily biodegraded by a microorganism. More specifically, the first component (a water-soluble substrate) is small in molecular weight so as to dissolve in water and can be rapidly taken up by microorganisms typically found in the subsurface environment.

Persons of ordinary skill in the art will readily understand the interaction of various microorganisms and the conversion of a substantially aerobic subsurface environment into one that is primarily anaerobic. In a very simplified discussion of a complex subject, one could assume that the subsurface into which the microorganism activator (7) typically will be injected has at least pockets of aerobic water in which aerobic microorganisms flourish. In an aerobic environment, the microorganisms that primarily take up and consume the first component would be those that flourish in such an environment. The nourishment provided by the first component of the microorganism activator (7) sustains proliferation of those microorganisms that consume the component. If they are typical aerobic microorganisms (microorganisms that function best in the presence of oxygen), then they use up oxygen as they break down waste and other substances. More specifically, these typical aerobic microorganisms will utilize molecular oxygen as a terminal electron acceptor in their metabolism of energy-containing compounds. Thus, as they proliferate and as they consume the first component, they also will use up available oxygen in the subsurface environment. Ultimately a primarily aerobic undersurface environment may become a primarily anaerobic environment which is optimal for the work of anaerobic microorganisms—those that function best when oxygen is low or entirely absent. Anaerobic microorganisms typically exist in the subsurface and, when the environment becomes primarily anaerobic, and they are fed by introduction of the microorganism activator (7), they typically will proliferate. These typical anaerobic microorganisms use substances other than oxygen as their terminal electron acceptor. Some anaerobic microorganisms may produce hydrogen, while others (for example, anaerobic microorganisms such as dechlorinating bacteria) utilize hydrogen as their electron donors and thereby can biodegrade substances such as PCE and TCE.

Since the second component (a low solubility substrate) is large in molecular weight, the microorganism fails to rapidly consume the second component (a low solubility substrate). In a preferred embodiment, the second component (a low solubility substrate) is biodegraded by an anaerobic hydrogen-generating microorganism over a long period of time. Specifically, the second component (a low solubility substrate) requires a long period of time to be biodegraded by a microorganism, thereby enabling long-term biodegradation reaction by a microorganism.

A preferred embodiment of the microorganism activator (7) comprising the first component and the second component utilizes glycerin as the first component and soybean oil as the second component. Thus, as described hereinabove, the two components provide both quickly available carbon (glycerin) and slow-release carbon (soybean oil) as nutrient sources for microorganisms. When injected into an environment that initially contains significant subsurface oxygen along with aerobic microorganisms, and that also contains anaerobic microorganisms susceptible to biostimulation, the aerobic microorganisms may initially utilize molecular oxygen as a terminal electron acceptor in their metabolism of the first component, glycerin. The subsurface environment typically will then become more hospitable to anaerobic microorganisms as the subsurface oxygen is depleted. The second component, soybean oil, is well-suited to long-term nourishment of anaerobic microorganisms and can advantageously biostimulate and maintain such microorganisms over a long period of time.

Depending on the environmental conditions and targeted contaminants present in the subsurface environment, the microorganism activator (7) of this preferred embodiment can provide an anaerobic condition rapidly and can generate and slowly-release hydrogen over a long period of time at the same time.

Moreover, even when a high pressure is applied on said microorganism activator (7) to be jetted on the soil, the oil droplets will not adhere to each other to grow larger in size. Therefore, the droplet size of the microorganism activator (7) is not easily susceptible to change, i.e. does not become too large.

If the droplet size of the microorganism activator (7) becomes too large, the microorganism activator (7) may not permeate the soil.

Even when a high pressure is applied on said microorganism activator (7) used in the present invention to be jetted on the soil, a significant increase in the diameter is controlled to prevent the above-stated disadvantage. Since said microorganism activator (7) used in the present invention contains a surfactant, by emulsifying the oil in the second component can prevent the formation of large droplets.

Even when said microorganism activator (7) is jetted from a nozzle as a jet capable of cutting the contaminated soil (Gp), an environment that activates the anaerobic microorganism in the contaminated soil (Gp) is provided rapidly and said microorganism that generates hydrogen is assuredly activated, and a condition of activating a microorganism (e.g. a dechlorinating bacterium) that biodegrades a contaminant (a condition on which hydrogen is generated and slowly-released) can be maintained.

Herein, according to inventors of the present invention, said microorganism activator (7) can have a shelf life of at least two months. Therefore, even when said microorganism activator (7) is used at a place remote from a production site of said microorganism activator (7) and transportation thereof requires a long period of time and waiting time until construction, the preferred embodiment of the microorganism activator (7) remains constant in quality, assuredly generates hydrogen in the soil of a typical environment with a typical microorganism population, and biodegradation reaction of a toxic chemical substance by said microorganism can be assuredly promoted.

### BRIEF DESCRIPTION OF THE DRAWINGS

FIG. 1 is a diagram explaining the outline of a first embodiment of the present invention.

FIG. 2 is a diagram showing a boring hole drilling process in the first embodiment.

FIG. 3 is a diagram showing a slit preparing process in the first embodiment.

FIG. 4 is a diagram showing a pressurizing and injecting process of a microorganism activator in the first embodiment.

FIG. 5 is a diagram showing a monitor moving process in the first embodiment.

FIG. 6 is a diagram showing a process of preparing a slit by using the monitor moved by the process as shown in FIG. 5 and pressurizing and injecting a microorganism activator.

FIG. 7 is a diagram showing variations of the first embodiment.

FIG. 8 is a diagram illustrating problems of the first embodiment.

FIG. 9 is a perspective view showing a second embodiment of the present invention.

FIG. 10 is a plan view showing variations of the second embodiment of the present invention.

FIG. 11 is a diagram illustrating a third embodiment of the present invention.

FIG. 12 is a diagram showing a boring hole drilling process of a fourth embodiment of the present invention.

FIG. 13 is a diagram showing a conical surface cutting process of the fourth embodiment.

FIG. 14 is a diagram showing the state of blocking by a packer of the fourth embodiment.

FIG. 15 is a diagram showing a pressurizing and injecting process of a remediating agent of the fourth embodiment.

### DETAILED DESCRIPTION OF ILLUSTRATIVE EMBODIMENTS

### Best Mode for Carrying Out the Invention

With reference to the attached drawings, embodiments of the present invention will be described.

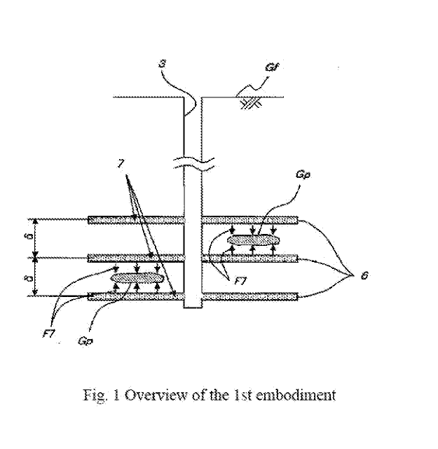

A first embodiment will be described based on FIGS. 1 to 6.

FIG. 1 shows the outline of a contaminated soil remediation method according to the first embodiment of the present invention.

The contaminated soil remediation method according to the first embodiment comprises a boring hole cutting process, a jet device inserting process and a soil cutting process.

In FIG. 1, a three-stage disk-like (flat-plate) area (6) is formed at predetermined distances δ in the vicinity of the bottom of a boring hole (3) drilled vertically downward from a ground surface (Gf). Herein, a three-stage flat-plate area (6) is formed (shown), but a flat-plate area (6) is not limited to a three-stage shape.

A contaminated soil (Gp) containing a contaminant is present in the soil sandwiched by flat-plate areas in the vertical direction. A microorganism activator (7) is injected into said flat-plate areas (6), and the microorganism activator (7) activates and proliferates a hydrogen-generating microorganism present in the areas (6) to generate hydrogen. Generated hydrogen permeates the soil and reaches the contaminated soil (Gp). (arrow F7)

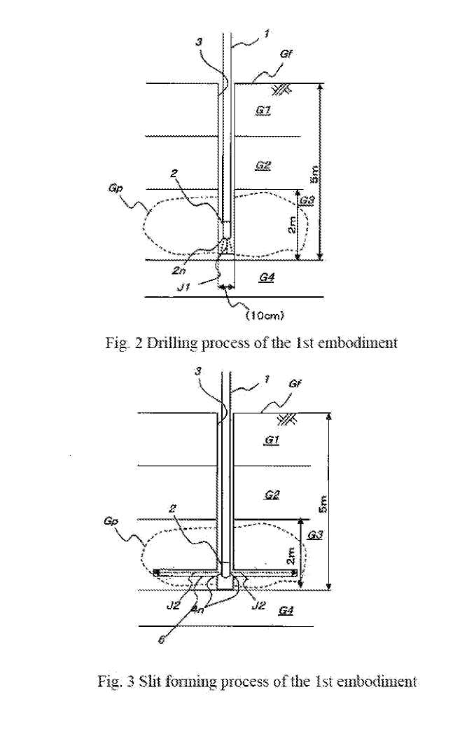

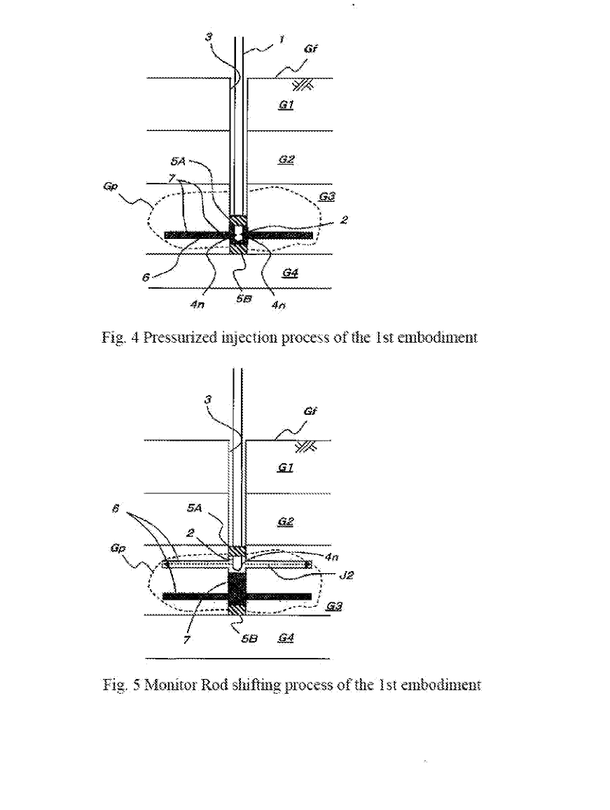

In the first embodiment, the boring hole (3) that extends in the vertical direction and reaches the contaminated soil (Gp) (area to be purified) is cut (FIG. 2). A rod (1) whose end is provided with a jet device (2) is inserted into the boring hole (3) (FIG. 3), and the jet device (2) is rotated at every predetermined depth in the longitudinal direction of the boring hole (3) to jet and inject the microorganism activator (7) in the radial direction (FIG. 4).

As shown in FIG. 3, and as mentioned later, water is jetted from the jet device (2) to cut the soil and then the microorganism activator (7) is injected into the cut area. Herein, it is possible to inject the microorganism activator (7) into the area (6) while jetting the microorganism activator (7) from the jet device (2) to cut the soil.

When the soil containing the contaminated soil (Gp) is cut to form the flat-plate area (6) into which the microorganism activator (7) was injected, the jet device (2) is moved by a predetermined distance δ in the vertical direction to additionally form the flat-plate area (6) into which the microorganism activator (7) was injected (FIG. 5).

Said microorganism activator (7) in the soil cutting process has a first component, which is effective to activate aerobic microorganisms and may be selected from the group comprising a short chain fatty acid, a short chain fatty acid salt, an alcohol and a carbohydrate, a second component, which is effective to activate anaerobic microorganisms and may be selected from the group comprising a soybean oil, a corn oil, a canola oil, an olive oil, a peanut oil, a coconut oil, a palm oil, a rape oil, a fish oil, a butter, a jojoba oil, a carnauba wax and a long chain fatty acid and a third component comprising a surfactant. Also, the microorganism activator (7) has its median particle diameter remain within the range of 0.3 to 3 μm (i.e. a stable condition) when injected into the soil with a jet pressure of 50 MPa or less.

In the first embodiment, it is preferable that said microorganism activator (7) further contain at least one of nitrogen, phosphorus and vitamin B12 (cobalamin).

Also, it is preferable that said microorganism activator (7) further contain a sucrose fatty acid ester.

In addition, preferably, the first component is glycerin, the second component is soybean oil, and water is contained in the microorganism activator.

In the first embodiment, said flat-plate area (6) may be disk-like or a flat shape having a planar shape (e.g. fan-shape) other than a circular-shape.

When a fan-shape area (6) is formed, the jet device (2) is rotated at a predetermined angle (the central angle of a fan) relative to the central axis of the boring hole (3).

Herein, the vertical direction interval δ of the flat-plate area (6) (a distance of moving the jet device in the vertical direction: a pull-up distance of the jet device) is affected by the remediating period, the concentration of a microorganism activator, the number of microorganisms and soil property. In particular, a significant correlation between the vertical direction interval δ and the remediating period is shown, and the remediating period provides a dominant factor for the vertical direction interval δ. If the remediating period is established, the range of the vertical direction interval δ can be determined.

An inventors' experiment found that when said vertical direction interval δ is 0.2 m or less, the ground will consequently be finely crushed, resulting in significant reduction in the strength of the ground, longer construction period and growing construction costs.

Meanwhile, when said vertical direction interval δ exceeds 0.4 m, it was found that it takes hydrogen in amounts enough to activate a microorganism, a long period of time to reach and permeate an area between adjacent flat-plate areas (6) by molecular diffusion. Thus, if said vertical direction interval δ exceeds 0.4 m, the remediating period can be much longer.

Accordingly, said vertical direction interval δ (the vertical direction interval of an intermittently formed flat-plate area (6) is preferably 0.2 to 0.4 m.

Another inventors' experiment found that if the vertical direction interval δ is 0.3 m, reduction in the strength of the ground can be significantly controlled, and hydrogen assuredly permeates all the area between flat-plate areas by molecular diffusion in half a year or so.

Specifically, the inventors' experiments found that if the vertical direction interval δ is 0.3 m, such technical requests as “ground stability,” “sufficient remediating effect by using a microorganism activator (7)” and “reduction in construction costs and shorter construction period” can be met in a feasible period (half a year or so) at the same time and in a favorable manner.

Consequently, said vertical direction interval δ is most preferably 0.3 m.

In the first embodiment, the above inventors' experiment employed the microorganism activator (7), containing the following in composition: glycerin (first component) 4%, soybean oil (second component) 55%, surfactants (third component) 10%, stabilizing agents 0.2%, and water 30.8%.

The particle diameter of the microorganism activator (7) shows a median of 1.4 μm, 12 months after the microorganism activator (7) was produced.

Inventors have conducted a remediation experiment using the microorganism activator (7) set forth above.

The experiment was carried out with the same mode as the first embodiment illustrated in FIGS. 1 to 7, and the vertical direction interval δ was set to 0.3 m. Packers (5A), (5B) (FIGS. 4 to 5) were not applied. Tetrachloroethylene (PCE) is the chemical substance to be purified (targeted contaminant).

For soil, the soil leachate concentration (based on Japanese Soil Leaching Test) of PCE was 5.0 mg/L before remediation, and was reduced to 0.089 mg/L 13 months later.

In another place, the soil leachate concentration of PCE was 0.065 mg/L before remediation, and was reduced to 0.003 mg/L 13 months later.

For groundwater, PCE concentrations of the water (groundwater) in the monitoring wells installed in the contaminated area to be purified were analyzed. The groundwater concentration of PCE was 45.0 mg/L before remediation, and was reduced to undetectable level (less than 0.001 mg/L) 13 months later.

Also, in another place, the groundwater concentration of PCE was 173.8 mg/L before remediation, and was reduced to 0.048 mg/L 13 months later.

Next, with reference to FIGS. 2 to 6, construction procedures of a method for remediating a contaminated soil according to the first embodiment will be described in detail.

FIGS. 2 to 6 show a case where the contaminant (Gp) present in a tight clay layer (G3) as an aquitard is removed. The soil of the tight clay layer (G3) is a low permeable soil.

According to a process as shown in FIG. 2, a boring hole (3) with a diameter of 10 cm is drilled into e.g. a ground surface (G0 and then a soil comprised of a surface layer (G1), a sandy soil layer (G2), a tight clay layer (an aquitard) (G3) and a sandy soil layer (G4).

In FIG. 2, a boring rod (1) is lowered from the ground surface (G0 to drill a boring hole (3) while a fluid (J1) such as water is jetted from a nozzle (2n) of a lower end of a monitor (2) (a jet device) provided at an end of a boring rod (1). The boring hole (3) is drilled up to the vicinity of an under surface of the aquitard (G3).

In an illustrated embodiment, the depth from the ground surface (G0 to the under surface of the aquitard (G3) is e.g. 5 m, and the thickness of the aquitard (G3) is e.g. 2 m.

Next, in a process as shown in FIG. 3, while the monitor (2) is positioned in the vicinity of the bottom of the boring hole (3), a high-pressure water jet (J2) is jetted from a nozzle (4n) provided at an outer circumference of the monitor (2) in the horizontal direction and a flat-plate area (6) (slit) is cut while rotating the boring rod (1).

In the process as shown in FIG. 4, the boring rod (1) is first pulled out to the ground surface (Gf) (not shown), and a rod (a packer rod) for supplying a fluid (not shown) is attached to arrange a packer (5B) in the bottom of the boring hole (3), or a boundary between the aquitard (G3) and the sandy soil layer (G4).

The packer (5B) is readily arranged in the boring hole (3) at a predetermined position by contracting the packer (5B). After the packer (5B) reaches the bottom of the boring hole (3) (a boundary between the aquitard (G3) and the sandy soil layer (G4)), the fluid is supplied to the packer (5B) via a fluid feed pipe (not shown) to have the packer (5B) expanded.

When the packer (5B) is expanded, an inner circumference of the boring hole (3) and an outer circumference of the packer (5B) contact with each other, and consequently sealing property on the bottom of the boring hole (3) with the boring hole (3) downward, or with the sandy soil layer (G4), is ensured. Specifically, leakage of each fluid from the boring hole (3) to the sandy soil layer (G4) is prevented to seal the boring hole (3).

In FIG. 4, a packer (5A) is arranged at the upper side of the monitor (2) as well. The packer (5A) is different from the packer (5B) arranged on the bottom of the boring hole (3).

When the packer (5A) is placed like the packer (5B), a fluid is not supplied until the packer (5A) comes at the position just above the monitor (2), and the packer (5A) is contracted to be lowered into the boring hole (3). When the packer (5A) is arranged at the predetermined position just above the monitor (2), the fluid is supplied to expand the packer (5A).

When the fluid is supplied to the packer (5A), the inner circumference of the boring hole (3) and the outer circumference of the packer (5A) contact with each other, and an annular space between an outer circumference of the boring rod (1) and the inner circumference of the boring hole (3) is completely sealed with the packer (5A). As a result, sealing property from an area having the monitor (2) to a space of the upper side of the packer (5A) is ensured.

Herein, a fluid is supplied to the packer (5A) via e.g. a fluid feed pipe (not shown).

After the flat-plate area (6) is sealed with upper and lower packers (5A), (5B), the microorganism activator (7) is pressurized and injected from the nozzle (4n) of the monitor (2) to an area sandwiched with the packers (5A), (5B) at the boring hole (3). Herein, the soil in the area in which the microorganism activator (7) is pressurized and injected is the aquitard (G3), and the microorganism activator (7) is pressurized and injected into the flat-plate area (6) formed in the aquitard (G3).

When the microorganism activator (7) is pressurized and injected, a hydrogen-generating microorganism present in the flat-plate area (6) and its surrounding soil is activated and proliferated to generate hydrogen. Generated hydrogen activates and proliferates a microorganism (e.g. a dechlorinating bacterium) present in the aquitard (G3). Consequently, a toxic chemical substance (such as a VOC and an organic chlorine compound) in the aquitard (G3) is decomposed by a biological effect of the microorganism.

In addition, hydrogen generated by the hydrogen-generating microorganism present in the flat-plate area (6) and its surrounding soil permeates the aquitard (G3) by molecular diffusion, thereby supplying hydrogen to an area between the flat-plate areas (6) (an area in which the microorganism activator (7) is not injected) and having a microorganism (such as a dechlorinating bacterium) that decomposes a toxic chemical substance present therein activated and proliferated.

Therefore, the toxic chemical substance in the area between the flat-plate areas (6) (an area in which the microorganism activator (7) is not injected) is decomposed and purified.

When the microorganism activator (7) is injected, a driving source of a pump for injecting the microorganism activator (7) arranged on e.g. the ground (not shown) is controlled, thereby enabling the microorganism activator (7) to be dynamically injected and pressurized in e.g. sinusoidal-shape and pulse-mixing manners.

By changing dynamically the pressure for injecting microorganism activator (7), the microorganism activator (7) is effectively injected.

Next, in a process as shown in FIG. 5, the fluid is discharged from the packer (5A) to be contracted and the packer (5A) is pulled out from the boring hole (3) (not shown in FIG. 5). Then, the boring rod (1) and the monitor (2) are moved upward.

After the boring rod (1) and the monitor (2) are moved upward by a predetermined amount, the monitor (2) is rotated again and a high-pressure water jet (J2) is jetted from the jet nozzle (4n) in the horizontal direction to form a second-stage flat-plate area (6) upward from the flat-plate area (6) formed in the process shown in FIG. 3.

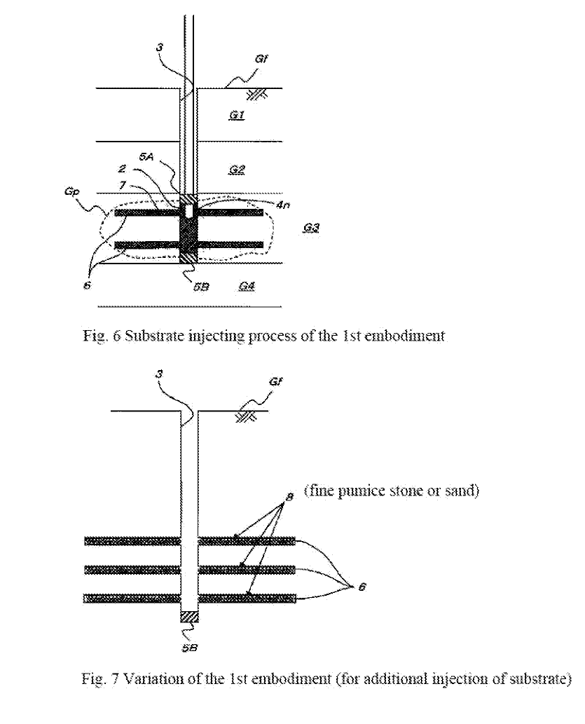

After forming the second-stage flat-plate area (6), in the process shown in FIG. 6, the packer (5A) is positioned just above the monitor (2) again to supply a fluid and expand the packer (5A). Then, the microorganism activator (7) is pressurized and injected from the jet nozzle (4n) of the monitor (2) into the second-stage flat-plate area (6) and an area to the packer (5A) arranged upward (a gap of the boring hole (3)).

With reference to FIGS. 2 to 6, the above-mentioned processes will be repeated.

FIG. 2 shows that when the boring hole (3) is drilled, a high-pressure water for drilling is jetted from the lower side of the monitor (2). However, in a process for drilling the boring hole (3) (FIG. 2) (not shown), the boring hole (3) is preferably drilled by driving or pushing-in. In this specification, a hole formed by driving or pushing-in can also be defined as a “boring hole.”

When the high-pressure water is jetted to drill the boring hole (3), a slime is generated. However, if the boring hole (3) is drilled by driving or pushing-in, no slime is generated, and diffusion of a toxic chemical substance such as a VOC and an organic chlorine compound by the slime is prevented. Appearance of the microorganism activator (7) on the ground is also prevented.

In addition, when the boring hole (3) is drilled by driving and pushing-in, no gap between the monitor (2) and the inner circumference surface of the boring hole (3) is found, thereby easily providing a sealing effect (airtight effect) by the packers (5A), (5B). Moreover, costs for removing a slime can be saved.

The packer (5B) is provided at the lower side of the monitor (2), because the injection pressure generated by injecting the microorganism activator (7) into a contaminated area most acts on the lower side of the monitor (2). As stated above, a sandy soil layer (G4) lies at the lower side of the aquitard (G3) as a contaminated area in FIGS. 2 to 6. When the microorganism activator (7) is pressurized and injected, the injection pressure acts on downward, thereby pushing the microorganism activator (7) and the toxic chemical substance into the sandy soil layer (G4) and causing diffusion via the sandy soil layer (G4).

Therefore, in the first embodiment, the packer (5B) is also arranged on the bottom of the boring hole (3) to expand the packers (5A), (5B) (“double packer”) in the vertical direction of the area in which the microorganism activator (7) is pressurized and injected. Accordingly, leakage of the microorganism activator (7) and the toxic chemical substance from the sandy soil layer (G4) at the lower side of the boring hole (3) is prevented.

In addition, no use of the packers (5A), (5B) is allowed.

According to the first embodiment (shown), said microorganism activator (7) contains glycerin (a first component). Soluble glycerin having a small molecular weight is readily biodegraded by a microorganism, thereby rapidly activating and proliferating the microorganism to consume oxygen in the flat-plate area (6) in which the microorganism activator (7) was injected and its surrounding area. After oxygen consumption, an aerobic microorganism in the soil (Gp) dies out, and oxygen around the soil (Gp) is completely consumed (by the microorganism). Consequently, the flat-plate area (6) and its surrounding area are provided with an anaerobic environment (an anaerobic condition) and thus a condition of activating and proliferating an anaerobic microorganism.

Because the anaerobic microorganism is activated and proliferated, hydrogen is generated in the flat-plate area (6) and its surrounding area, a microorganism that biodegrades a toxic chemical substance such as a VOC is activated and proliferated like a dechlorinating bacterium. Also, generated hydrogen permeates an area between the flat-plate areas (6) in the aquitard (G3) (an area in which the microorganism activator (7) was not injected) by molecular diffusion to activate and proliferate the microorganism that decomposes the toxic chemical substance in the area.

Meanwhile, since a soybean oil (a second component) has a high molecular weight, the microorganism fails to rapidly consume the second component. Thus, the second component is biodegraded for a long period of time by e.g. an anaerobic microorganism. Specifically, the soybean oil (a second component) can maintain a long period of biodegradation of a microorganism to generate hydrogen. Thus, generated hydrogen permeates the aquitard (G3) and a microorganism such as a dechlorinating bacterium maintains biodegradation reaction of decomposing a toxic chemical substance such as a VOC over a long period of time.

When the contaminated soil (Gp) is present in a soil having a high permeability, the microorganism activator (7) also permeates the soil having a high permeability in addition to hydrogen.

Even when a high pressure is applied on said microorganism activator (7) to be jetted on the soil (Gp), the oil droplet size will not become too large.

The viscosity thereof will not become too high, thereby preventing the microorganism activator (7) from failing to permeate the soil (Gp).

Inventors of the present invention confirmed that the microorganism activator (7) used in the first embodiment has a shelf life of at least two months. Therefore, even when transportation of the microorganism activator (7) from a production site to a construction site requires many hours and construction preparation also requires a long period of time, said microorganism activator (7) remains constant in quality and the particle diameter is maintained at a proper level when it is jetted and injected into the soil (Gp).

Herein, reduction in ground proof stress due to cutting the entire contaminated area might cause such major concerns as ground subsidence.

On the contrary, in the first embodiment as shown in FIGS. 1 to 6, only part of the contaminated area is cut in the vertical direction to form the flat-plate area (6), and injection of the microorganism activator (7) into the flat-plate area (6) is intermittently repeated in a step manner. As a result, compared to a case where the entire contaminated area is cut, reduction in ground proof stress at a construction region is significantly controlled to prevent ground subsidence, etc. Also, this process is capable of efficiently supplying the microorganism activator (7).

In the first embodiment as shown in FIGS. 1 to 6, a component that increases the specific gravity of said microorganism activator (7) is preferably contained.

Also, a component that increases the viscosity of said microorganism activator (7) is preferably contained.

Alternatively, a component that imparts a property of increasing the viscosity of said microorganism activator (7) (or so as to be thixotropic or gelatinous) is preferably contained.

After construction, even with an earth pressure on the flat-plate area (6), the microorganism activator (7) injected by increasing the specific gravity of the microorganism activator (7), increasing or changing the viscosity (so as to be thixotropic or gelatinous) stays in the soil, and thus prevents reverse flow to the ground.

Thereafter, the microorganism activator (7) stays in the soil (Gp) and can contribute to activating and proliferating a dechlorinating bacterium, etc.

In the first embodiment as shown in FIGS. 1 to 6, when the microorganism activator (7) is consumed by an aerobic microorganism and an anaerobic microorganism, the microorganism activator (7) can be additionally injected. The variations are shown in FIG. 7.

By additionally injecting the microorganism activator (7), the microorganism activator (7) is supplied to the contaminated soil at specific time intervals several times. Under the circumstances, since a microorganism can be activated over a long period of time even with a high content of a toxic chemical substance such as a VOC, the toxic chemical substance such as a VOC can assuredly be removed by biodegradation due to the microorganism such as a dechlorinating bacterium.

As for the injection, with reference to FIGS. 4 to 6, packers are arranged and expanded so that the flat-plate areas (6) intermittently formed in the vertical direction are each sandwiched, and the microorganism activator may be injected (supplies) into the flat-plate areas (6).

In variations as shown in FIG. 7, not only the microorganism activator, but also a small-diameter pumice (8) and sand (a small-diameter solid that shows favorable permeability of the microorganism activator (7)) are injected to fill the flat-plate areas (6). When the small-diameter pumice (8) and the sand are injected to fill the flat-plate areas (6), they may be jetted from the nozzle of the jet device (2) like the microorganism activator.

As shown in FIG. 7, the small-diameter pumice (8) and the sand are injected (filled) into the flat-plate areas (6) to hold the boring hole (3). When the microorganism activator (7) is consumed by the aerobic microorganism and the anaerobic microorganism, feeding of the microorganism activator (7) into the boring hole (3) has the flat-plate areas (6) filled with the small-diameter pumice (8) and the sand function as a “water passage” and the fed microorganism activator permeates the flat-plate areas (6).

In addition, as shown in FIG. 7, if a sealing material (5B) is arranged on the bottom of the boring hole (3), leakage of the microorganism activator (7) to an area deeper than the bottom of the boring hole (3) is prevented and the microorganism activator (7) is assuredly injected into the flat-plate areas (6) filled with the small-diameter pumice (8) and the sand.

Other configurations and effects of the variations shown in FIG. 7 are identical to the first embodiment shown in FIGS. 1 to 6.

The first embodiment with reference to FIGS. 1 to 7 describes a case where the contaminated soil (Gp) is found between adjacent flat-plate areas (6). When it takes hydrogen a long period of time to reach the contaminated soil (Gp), the toxic chemical substance might not be efficiently removed because the contaminated soil (Gp) is present in an area in which the microorganism activator (7) is not directly supplied (an area that doesn't cross with the flat-plate area (6)).

According to second to fourth embodiments with reference to FIGS. 8 to 15, even when it takes hydrogen a long period of time to reach the contaminated soil (Gp), the microorganism activator (7) is directly supplied to the contaminated soil (Gp), thereby enabling the toxic chemical substance to be efficiently removed by biodegradation reaction of the microorganism.

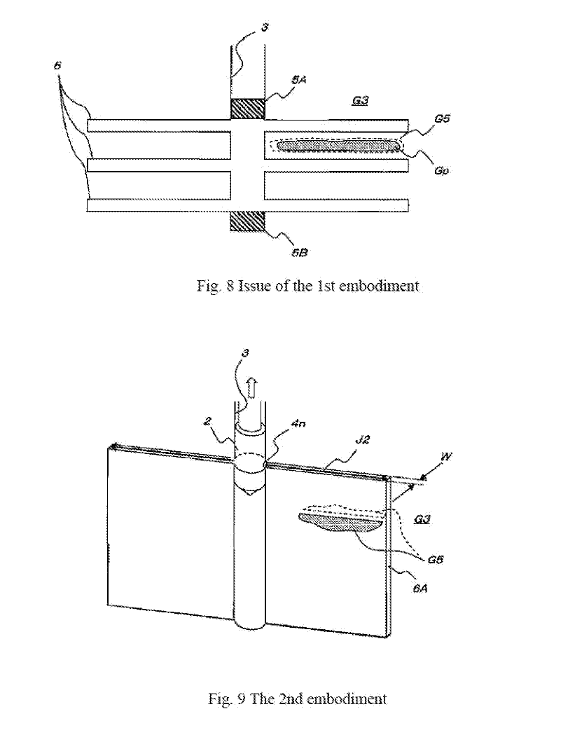

With reference to FIGS. 8 and 9, a second embodiment of the present invention will be described.

In the first embodiment shown in FIGS. 1 to 7, as shown in, e.g., FIG. 8, a contaminated area (G5) is present in a soil in which a microorganism activator (7) less efficiently permeates, e.g. an aquitard (G3), and when the size of the contaminated area (G5) in the depth direction is small (thin), flat-plate areas (6) don't cross with a contaminated area (Gp) and the microorganism activator (7) is not directly injected thereinto as shown in FIG. 8. Therefore, when it takes hydrogen a long period of time to reach the contaminated area (Gp), it cannot be expected that a microorganism that biodegrades a toxic chemical substance is efficiently activated and proliferated. Thus, the toxic chemical substance might not be efficiently removed.

Conversely, in the second embodiment, as shown in, e.g., FIG. 9, a high-pressure water jet (J2) jetted in the horizontal direction is moved in the vertical direction without rotating a monitor (2), and the aquitard (G3) is cut in the vertical direction to form a flat-plate area (6A) that extends in the vertical direction. In FIG. 9, the size of the flat-plate area (6A) in the width direction is denoted by W and is significantly small (flat-plate area (6A) is thin)).

If the microorganism activator (7) (not shown in FIG. 9) is pressurized and injected into the cut aquitard continuously cut in the vertical direction (a flat-plate area (6A)), the flat-plate area (6A) in which the microorganism activator (7) was injected crosses with the area (G5) contaminated with a toxic chemical substance (a VOC contaminated area) as shown in FIG. 9. Then, the microorganism activator (7) is assuredly supplied to the contaminated area (G5), and an activated and proliferated microorganism generates hydrogen, and generated hydrogen has a microorganism that biodegrades a toxic chemical substance such as a dechlorinating bacterium activated and proliferated to biodegrade the toxic chemical substance.

Since a microorganism that generates hydrogen and a microorganism that biodegrades a toxic chemical substance in the contaminated area (Gp) are activated and proliferated, the contaminated area (Gp) is efficiently purified.

In FIG. 9, the flat-plate area (6A) is cut in the horizontal direction of FIG. 9 relative to the boring hole (3). The flat-plate area (6A) can be cut in either right or left direction (e.g. only in the right direction of FIG. 9).

Herein, when the flat-plate area (6A) that extends in the vertical direction is formed, e.g. a high-pressure water jet is linearly jetted and the monitor (2) may be moved in the vertical direction (not shown).

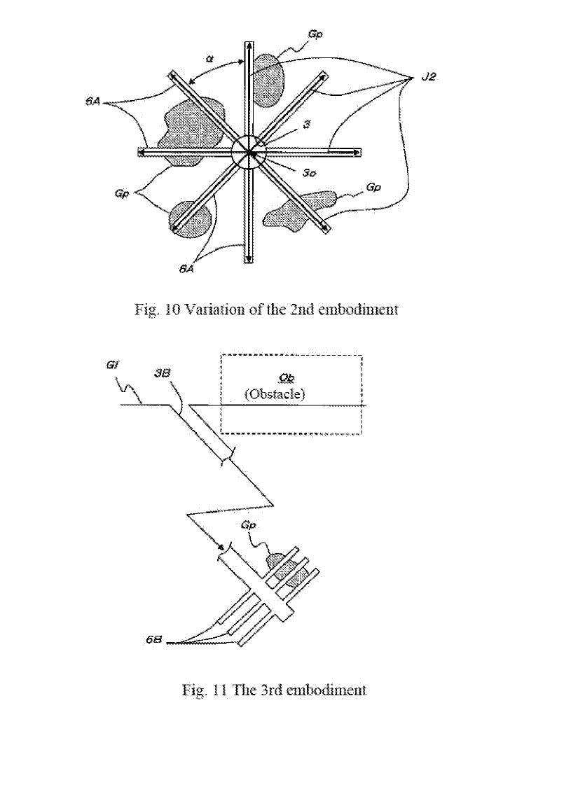

FIG. 10 shows variations of the second embodiment.

FIG. 9 shows that a single flat-plate area (6A) extends in the vertical direction, while FIG. 10 shows variations in which a flat-plate area (6A) extends in the vertical direction relative to the center point 3o of the boring hole (3) and a plurality of flat-plate areas (6A) radially extend. In FIG. 10, an angle (a central angle) formed by adjacent flat-plate areas (6A) is denoted by a. As for the variations shown in FIG. 10, a central angle α formed by a plurality of flat-plate areas (6A) is identical.

The variations shown in FIG. 10 are effective at a construction site having a plurality of contaminated areas (Gp).

According to the second embodiment shown in FIGS. 9 and 10, since the flat-plate area (6A) assuredly crosses with the contaminated area (Gp), the microorganism activator (7) is assuredly supplied to a microorganism present in the contaminated area (Gp), thereby activating and proliferating a hydrogen-generating microorganism and a microorganism that biodegrades a toxic chemical substance in the contaminated area (Gp). As a result, the contaminated area (Gp) is efficiently purified.

Other configurations and effects of the second embodiment shown in FIGS. 9 and 10 and variations thereof are the same as the first embodiment shown in FIGS. 1 to 7. Herein, in the second embodiment, packers (5A), (5B) (FIGS. 4 to 8) may or may not be provided like in the first embodiment.

Next, the third embodiment will be described with reference to FIG. 11.

According to the third embodiment shown in FIG. 11, a boring hole (3B) is drilled in a slant direction (diagonally) relative to the horizontal surface.

The subsequent processes are the same as those in the first embodiment with reference to FIGS. 1 to 7.

The third embodiment is desired in cases where an obstacle Ob is present just above e.g. a contaminated soil (Gp), thereby failing to drill a boring hole in the vertical direction.

Other configurations and effects in the third embodiment shown in FIG. 11 are the same as each embodiment shown in FIGS. 1 to 10. In the third embodiment, packers (5A), (5B) (FIGS. 4 to 8) may or may not be provided.

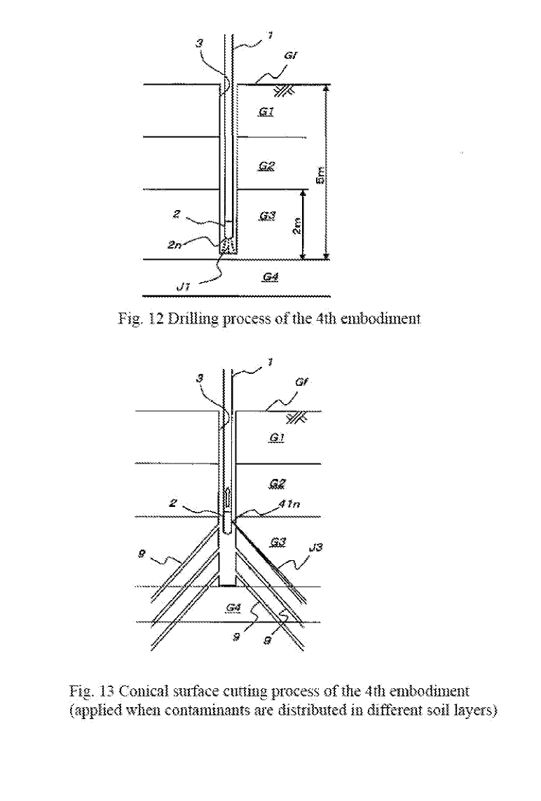

Next, with reference to FIGS. 12 to 15, the fourth embodiment of the present invention will be described.

In the fourth embodiment shown in FIGS. 12 to 15, a flat-plate area in which a microorganism activator (7) is injected (denoted by symbol 9 in FIGS. 13 to 15) is a shape along a conical or a truncated cone side surface. Specifically, “flat-plate” in this specification is used to express a concept including a shape along a conical or a truncated cone side surface.

FIGS. 12 to 15 show each process of the fourth embodiment by order of construction.

In a process shown in FIG. 12, a boring hole (3) is drilled up to the vicinity of a boundary between an aquitard (G3) and a sandy soil layer (G4).

In FIGS. 12 to 15, a ground surface (G0 is illustrated, followed by a surface layer (G1), a sandy soil layer (G2), a clay layer (aquitard) (G3) and a sandy soil layer (G4).

In a process shown in FIG. 13, a high-pressure water jet (J3) is jetted from a nozzle 41n turning slant downward provided at a jet device (2) to rotate a boring rod (1) and a monitor (2). Accordingly, the high-pressure water jet (J3) is jetted on a shape along a conical (or a truncated cone) side surface, thereby cutting a construction ground into a shape along a conical (or a truncated cone) side surface.

Then, by pulling up the jet device (2) and jetting the high-pressure water jet (J3) from the jet device (2) to rotate the jet device (2), a plurality of areas (a conical surface) (9) cut into a shape along a conical (or a truncated cone) side surface are formed from the bottom of the aquitard (G3) upward in the vertical direction.

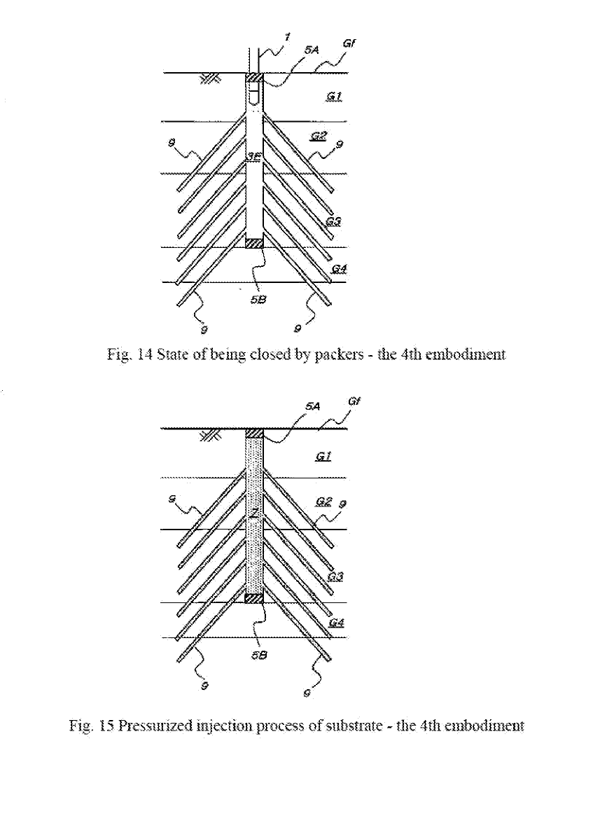

In a process shown in FIG. 14, the boring rod (1) is first pulled out to the ground surface (Gf) (not shown).

In FIG. 14, a packer (5B) is arranged on the bottom of the boring hole (3). When the packer (5B) is arranged on the bottom of the boring hole (3), a fluid is not supplied thereto and the packer (5B) is moved in the boring hole (3) with being contracted therein. If the packer (5B) is arranged on the bottom of the boring hole (3) (the vicinity of a boundary between the aquitard (G3) and the sandy soil layer (G4)), a fluid is supplied thereto to expand the packer (5B).

In addition, the packer (5A) is arranged in the vicinity of the ground surface (Gf) of the boring hole (3). Then, a fluid is supplied to the packer (5A) to expand the packer (5A).

By expanding the packers (5A), (5B), a plurality of areas (9) formed (an area shaped along a conical or a truncated cone side surface) and the packers (5A), (5B) block the boring hole (3) to seal the same against any fluid.

In FIG. 14, an area blocked by sealing a fluid with the packers (5A), (5B) is denoted by symbol 3E.

In a process shown in FIG. 15, the microorganism activator (7) is pressurized and injected from a monitor (2) relative to an area (an area blocked by sealing a fluid with the packers (5A), (5B)) denoted by sign 3E in FIG. 14.

FIG. 15 shows that the pressurized and injected microorganism activator (7) is filled in the area 3E (an area shaped along a conical or a truncated cone side surface (9), an area between the packers (5A), (5B) in the boring hole (3)). The microorganism activator (7) equally spreads to an end of the conical surface (9) along an area shaped along a conical (or a truncated cone) side surface (9).

After the microorganism activator (7) is pressurized and injected into an area blocked by sealing a fluid with the packers (5A), (5B) (a plurality of conical surfaces (9) formed and an area between the packers (5A), (5B) in the boring hole (3)), like each embodiment shown in FIGS. 1 to 11, the microorganism activator (7) activates and proliferates a hydrogen-generating microorganism to generate hydrogen after a predetermined time elapses. Since generated hydrogen permeates the soil as well as an area between the areas (9) in which a microorganism activator (7) was not directly injected, thereby having a microorganism such as a dechlorinating bacterium activated and proliferated over the entire construction area to biodegrade a toxic chemical substance such as a VOC and remediate the contaminated soil.

Thereafter, since the microorganism activator (7) is injected into an area shaped along a conical (or a truncated cone) side surface (9), and assuredly crosses with the area contaminated by the toxic chemical substance, thereby directly supplying the microorganism activator (7) to the contaminated area. Therefore, in the contaminated area, a hydrogen-generating microorganism and a microorganism that biodegrades the toxic chemical substance are activated and proliferated, which efficiently decomposes the toxic chemical substance present in the area and remediates the area.

Herein, an area shaped along a conical (or a truncated cone) side surface (9) extends over a plurality of layers ((G2) to (G4)), and the fourth embodiment shown in FIGS. 12 to 15 is particularly effective when the contaminated soil (Gp) is present in a plurality of layers.

Other configurations and effects of the fourth embodiment shown in FIGS. 12 to 15 are the same as each embodiment shown in FIGS. 1 to 11.

In the fourth embodiment, the interval of an area shaped along a conical (or a truncated cone) side surface (9) in the vertical direction (a distance of moving a jet device in the vertical direction: a pull-up distance of the jet device) is preferably 0.2 to 0.4 m, particularly 0.3 m.

In the fourth embodiment, packers (5A), (5B) (FIGS. 4 to 8) may or may not be provided.

The embodiments shown are exemplary only, and are not descriptions intended to limit the technical scope of the present invention.

For example, when a microorganism that can biodegrade and thus remove a toxic chemical substance is not present or is not sufficiently present in a contaminated soil, said microorganism can be injected into the soil after or during the injection of the microorganism activator.

In addition, iron powder can be injected into the contaminated soil.

Although various elements of the invention have been previously described and identified, the following is an illustrative listing of elements for ease of reference, and not intended to be limiting as to the scope of the invention.

### LISTING OF ELEMENTS

1 . . . boring rod
2 . . . jet device
(2n) . . . nozzle of the end of jet device
3 . . . boring hole
(4n) . . . nozzle in the horizontal direction
(5A), (5B) . . . packer
6 . . . flat-plate area
6A . . . flat-plate area
6B . . . flat-plate area
7 . . . microorganism activator
8 . . . pumice
9 . . . area shaped along a conical or a truncated cone side surface
G1 . . . surface layer
G2 . . . sandy soil layer
G3 . . . aquitard
G4 . . . soil layer
G5 . . . contaminated area
Gf . . . ground surface
Gp . . . contaminated area
J1 . . . fluid
J2 . . . high-pressure water jet
J3 . . . high-pressure water jet

Although the invention has been shown and described with reference to certain and illustrative embodiments, those skilled in the art will undoubtedly find alternative embodiments obvious after the reading of this disclosure. With this in mind, the following claims are intended to define the scope of protection to be afforded the inventors, and those claims shall be deemed to include equivalent constructions insofar as they do not depart from the spirit and scope of the present invention.

1. A contaminated soil remediation method for activating microorganisms in contaminated soil to remediate the contaminated soil, comprising:
forming a boring hole accessing a contaminated soil;
inserting a rod having a jet device into the boring hole;
cutting the contaminated soil in a manner forming a flat-plate area in which the contaminated soil is intermittently cut, and mixing the contaminated soil with a microorganism activator by jetting the microorganism activator into the contaminated soil cut by the jet device; and
the microorganism activator comprising at least one of a soybean oil, a corn oil, a canola oil, an olive oil, a peanut oil, a coconut oil, a palm oil, a rape oil, a fish oil, a butter, a jojoba oil, a carnauba wax and a long chain fatty acid.

2. A contaminated soil remediation method for activating microorganisms in contaminated soil to remediate the contaminated soil, comprising:
forming a boring hole accessing a contaminated soil;
inserting a rod having a jet device into the boring hole;
cutting the contaminated soil in a manner forming a flat-plate area in which the contaminated soil is intermittently cut, and mixing the contaminated soil with a microorganism activator by jetting the microorganism activator into the contaminated soil cut by the jet device; and
the microorganism activator comprising, a first component selected from a group comprising at least one of a short chain fatty acid, a short chain fatty acid salt, an alcohol and a carbohydrate, and a second component selected from the group comprising at least one of a soybean oil, a corn oil, a canola oil, an olive oil, a peanut oil, a coconut oil, a palm oil, a rape oil, a fish oil, a butter, a jojoba oil, a carnauba wax and a long chain fatty acid.

3. The contaminated soil remediation method according to claim 1, wherein the microorganism activator is comprised of particles, the median diameter of said particles being between 0.3 to 3 μm, and said particles being stable at a pressure of 50 MPa or under.

4. The contaminated soil remediation method according to claim 1, wherein said microorganism activator comprises at least one of nitrogen, phosphorus and vitamin B12.

5. The contaminated soil remediation method according to claim 1, wherein said microorganism activator comprises a sucrose fatty acid ester.

6. The contaminated soil remediation method according to claim 1, wherein said microorganism activator further comprises water, and wherein a first component comprises glycerin, and a second component comprises said soybean oil.

7. The contaminated soil remediation method according to claim 3, wherein said microorganism activator further comprises water, and wherein a first component comprises glycerin, and a second component comprises said soybean oil.

8. The contaminated soil remediation method according to claim 4, wherein said microorganism activator further comprises water, and wherein a first component comprises glycerin, and a second component comprises said soybean oil.

9. The contaminated soil remediation method according to claim 5, wherein said microorganism activator further comprises water, and wherein a first component comprises glycerin, and a second component comprises said soybean oil.

10. The contaminated soil remediation method according to claim 1, wherein said microorganism activator comprises at least one of, a component that increases specific gravity of the microorganism activator, a component that increases viscosity of the microorganism activator, and a component that imparts a property of changing the viscosity of the microorganism activator.

11. The contaminated soil remediation method according to claim 3, wherein said microorganism activator comprises at least one of, a component that increases specific gravity of the microorganism activator, a component that increases viscosity of the microorganism activator, and a component that imparts a property of changing the viscosity of the microorganism activator.

12. The contaminated soil remediation method according to claim 6, wherein said microorganism activator comprises at least one of, a component that increases specific gravity of the microorganism activator, a component that increases viscosity of the microorganism activator, and a component that imparts a property of changing the viscosity of the microorganism activator.

13. The contaminated soil remediation method according to claim 7, wherein said microorganism activator comprises at least one of, a component that increases specific gravity of the microorganism activator, a component that increases viscosity of the microorganism activator, and a component that imparts a property of changing the viscosity of the microorganism activator.

14. The contaminated soil remediation method according to claim 5, wherein said microorganism activator comprises at least one of, a component that increases specific gravity of the microorganism activator, a component that increases viscosity of the microorganism activator, and a component that imparts a property of changing the viscosity of the microorganism activator.

15. The contaminated soil remediation method according to claim 1, further comprising additionally injecting said microorganism activator into the flat-plate area, in which the contaminated soil is cut by said soil cutting process.

16. The contaminated soil remediation method according to claim 3 further comprising additionally injecting said microorganism activator into the flat-plate area in which the contaminated soil is cut by said soil cutting process.

17. The contaminated soil remediation method according to claim 7 further comprising additionally injecting said microorganism activator into the flat-plate area in which the contaminated soil is cut by said soil cutting process.

18. The contaminated soil remediation method according to claim 13 further comprising additionally injecting said microorganism activator into the flat-plate area in which the contaminated soil is cut by said soil cutting process.

19. A contaminated soil purification method comprising;
forming a boring hole accessing a contaminated soil;
inserting a rod having a jet device into the boring hole;
cutting the contaminated soil in a manner forming a flat-plate area in which the contaminated soil is intermittently cut, and mixing the contaminated soil with a microorganism activator by jetting the microorganism activator into the contaminated soil cut by the jet device to activate microorganisms in the contaminated soil to cause the microorganisms to consume contaminants in the contaminated soil, and thereby purify the soil; and
the microorganism activator comprising at least a component selected from materials effective to activate anaerobic microorganisms.

20. The contaminated soil purification method of claim 19, wherein the microorganism activator further comprises at least another component selected from materials effective to activate aerobic microorganisms.
